(19) United States
(12) Patent Application Publication
(10) Pub. No.: US 2025/0069071 A1
(43) Pub. Date: Feb. 27, 2025

(54) TRANSFER PROTOCOL USING DECENTRALIZED IDENTIFIERS AND VERIFIABLE CREDENTIALS

(71) Applicant: American Express Travel Related Services Company, Inc., New York, NY (US)

(72) Inventors: Andrew Lei, Brooklyn, NY (US); Mukund Shankar SimhaRaghu, Phoenix, AZ (US); Ajay Babu Maddukuri, Phoenix, AZ (US)

(21) Appl. No.: 18/454,224

(22) Filed: Aug. 23, 2023

(51) Int. Cl. G06Q 20/38; G06Q 20/22

(52) U.S. Cl. CPC G06Q 20/3825; G06Q 20/223; G06Q 20/3829

(57) ABSTRACT

Disclosed are various embodiments for payment protocols using decentralized identifiers (DIDs) and verifiable credentials (VCs). Various embodiments can receive a transfer peer DID comprising at least a first account peer DID, a second account peer DID, and instructions to initiate a transfer for a transfer amount between a first user record and a second user record. The first user record can be identified by the first account peer DID. The second user record can be identified by the second account peer DID. Various embodiments can generate a VC for the first account peer DID that comprises at least an authorization amount that represents an account balance that has been increased or decreased by the transfer amount. In various embodiments, the VC can be signed by a private key associated with an institution DID. Various embodiments can then send the VC to the client device.

### BACKGROUND

Decentralized Identifiers (DIDs) are globally unique identifiers that enable individuals, organizations, or things to have verifiable and self-owned digital identities. Verifiable credentials are data structures that represent claims about some attribute, qualification, or achievement related to a specified DID. Transfer protocols can be used to exchange information (e.g., data, currency, etc.) securely and privately between parties.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIG. 3 is a flowchart illustrating one example of functionality implemented as portions of an application executed in an institution computing environment in the network environment of FIG. 2 according to various embodiments of the present disclosure.

FIG. 4 is a flowchart illustrating one example of functionality implemented as portions of an application executed in an institution computing environment in the network environment of FIG. 2 according to various embodiments of the present disclosure.

FIG. 5 is a flowchart illustrating one example of functionality implemented as portions of an application executed in an institution computing environment in the network environment of FIG. 2 according to various embodiments of the present disclosure.

FIG. 6 is a flowchart illustrating one example of functionality implemented as portions of an application executed in an institution computing environment in the network environment of FIG. 2 according to various embodiments of the present disclosure.

FIG. 7 is a flowchart illustrating one example of functionality implemented as portions of an application executed in a client device in the network environment of FIG. 2 according to various embodiments of the present disclosure.

FIG. 8 is a flowchart illustrating one example of functionality implemented as portions of an application executed in a client device in the network environment of FIG. 2 according to various embodiments of the present disclosure.

FIG. 9 is a sequence diagram illustrating interactions between various components of the network environment of FIG. 2 according to various embodiments of the present disclosure.

FIG. 10 is a flowchart illustrating one example of functionality implemented as portions of an application executed in a client device in the network environment of FIG. 2 according to various embodiments of the present disclosure.

FIG. 11 is a flowchart illustrating one example of functionality implemented as portions of an application executed in a client device in the network environment of FIG. 2 according to various embodiments of the present disclosure.

FIG. 12 is a sequence diagram illustrating interactions between various components of the network environment of FIG. 2 according to various embodiments of the present disclosure.

### DETAILED DESCRIPTION

Disclosed are various approaches for a transfer protocol using decentralized identifiers (DIDs) and verifiable credentials (VCs). DIDs are unique identifiers that enable individuals, organizations, or things to have verifiable and self-owned digital identities. DIDs can be used for various purposes, but no standard protocol exists for holders of DIDs to authorize a transfer of information by another party using DIDS and VCs. By utilizing DIDs and VCs, fraud could be prevented, and users can gain greater trust in the system. Additionally, in at least some embodiments, the DIDs can be peer DIDs, which can be used to share information privately between two parties.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

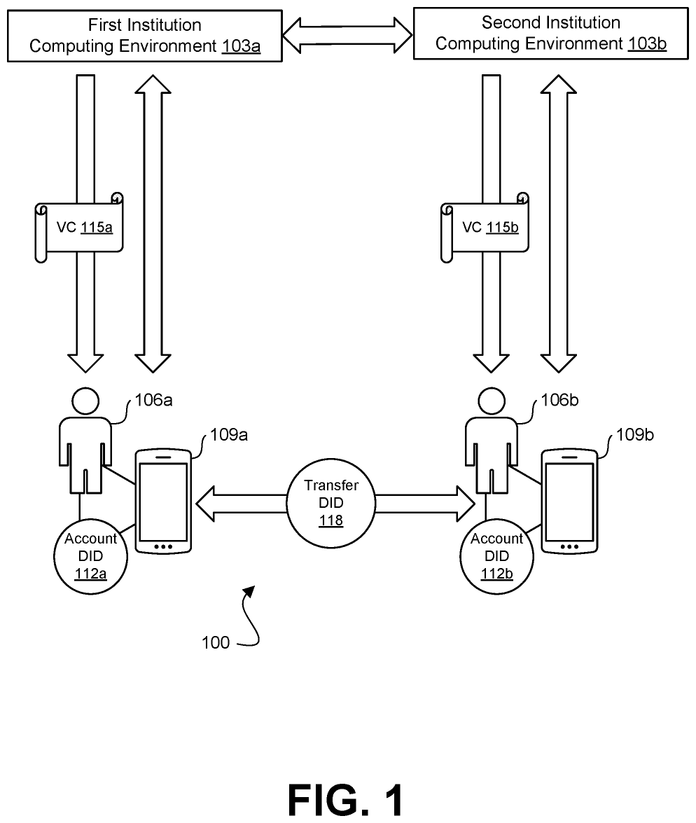

Referring to FIG. 1, shown is a trust over IP (TOIP) environment 100 according to the disclosure. The TOIP environment 100 illustrates various trust relationships that shows some of the actors that could be involved in one or more transfers according to examples of the disclosure. As shown in FIG. 1, the various trust relationships involve a first institution (e.g., an issuer of DIDs, a data provider, a financial institution, etc.), represented by a first institution computing environment 103a; a second institution (e.g., an issuer of DIDs, a data provider, a financial institution, etc.), represented by a second institution computing environment 103b; a first user 106a having a first client device 109a; and a second user 106b having a second client device 109b.

The first institution computing environment 103a can identify a first user 106a with an associated first account DID 112a. In at least some embodiments, the first institution computing environment 103a can issue the first account DID 112a to the first user 106a on the first client device 109a. In at least another embodiment, the first client device 109a can generate the first account DID 112a and the first institution computing device 103a can store an association between the first account DID 112a and the first user 106a on the first institution computing environment 103a. The first institution computing environment 103a can issue a first verifiable credential (VC) 115a to the first user 106a on a first client device 109a. The first institution computing environment 103a can issue a first VC 115a associated with the first account DID 112a that can be used to demonstrate a claim about the first user 106a. In one embodiment, a first institution computing environment 103a can issue a first VC 115a that includes a purchasing power (e.g., a credit limit, a bank account balance, the sum thereof, etc.) for one or more accounts maintained by the first institution computing environment 103a. In another embodiment, a first institution computing environment 103a can issue a first VC 115a that includes a transfer limit (e.g., a data transfer limit, a maximum data quota, etc.) for one or more accounts maintained by the first institution computing environment 103a. The first VC 115a can be used to verify the veracity of the claim to a second user 106b using a second client device 109b. For instance, the second user 106b can verify that the first user 106a has a requisite purchasing power or transfer limit and trust that the information is correct by checking that the first institution computing environment 103a has signed the first VC 115a.

Similarly, the second institution computing environment 103b can identify the second user 106b with an associated second account DID 112b. In at least some embodiments, the second institution computing environment 103b can issue the second account DID 112b to the second user 106b on the second client device 109b. In at least another embodiment, the second client device 109a can generate the second account DID 112b and the second institution computing device 103b can store an association between the second account DID 112b and the second user 106b on the second institution computing environment 103b. The second institution computing environment 103b can issue a second verifiable credential (VC) 115b to the second user 106b on the second client device 109b. The second institution computing environment 103b can issue a second VC 115b associated with the second account DID 112b that can be used to demonstrate a claim about the second user 106b. In one embodiment, a second institution computing environment 103b can issue a second VC 115b that includes a purchasing power (e.g., a credit limit, a bank account balance, the sum thereof, etc.) for one or more accounts maintained by the second institution computing environment 103b. In another embodiment, a second institution computing environment 103b can issue a second VC 115b that includes a transfer limit (e.g., a data transfer limit, a maximum data quota, etc.) for one or more accounts maintained by the second institution computing environment 103b. The second VC 115b can be used to verify the veracity of the claim to the first user 106a on the first client device 109a. For instance, the first user 106a can verify that the second user 106b has a requisite purchasing power or transfer limit and trust that the information is correct by checking that the second institution computing environment 103b has signed the second VC 115b.

In embodiments of the present disclosure, the first user 106a may want to securely transfer information (e.g., data, currency, etc.) to the second user 106b. In at least one embodiment, the first client device 109a can generate a transfer DID 118. While the first account DID 112a and the second account DID 112b represent the identities of the first user 106a or the second user 106b with respect to the first institution computing environment 103a or the second institution computing environment 103b respectively, the transfer DID 118 represents a transfer of information (e.g., data, currency, etc.) to be performed between the first institution computing environment 103a and the second institution computing environment 103b, as directed by the first user 106a and the second user 106b communicating over the first client device 109a and the second client device 109b. The first client device 109a can generate the transfer DID 118 that can include information about a transfer, like what is to be transferred, how much can be transferred, from where and to where the transfer is occurring, etc. In at least some embodiments, the first client device 109a can include or reference the first account DID 112a within the transfer DID 118. Additionally, the first client device 109a can include or reference proof that such a transfer can be made, such as including first verifiable credential 115a, within transfer DID 118.

In other embodiments of this disclosure, the second client device 109b can provide the second account DID 112b and the second VC 115b to the first client device 109a so that the first client device 109a can generate a transfer DID 118, as previously discussed. In such an embodiment, the first client device 109a can generate the transfer DID 118 to include or reference the first account DID 112a, the second account DID 112b, the first VC 115a, the second VC 115b, and/or various other information about the transfer, as previously discussed.

The first client device 109a can send the transfer DID 118 to the second client device 109b. Based on the terms provided in the transfer DID 118, the second user 106b can decide to accept or reject the transfer. If the second user 106b rejects the transfer DID 118, then the second client device 109b can notify the first client device 109a of such a rejection. If the first client device accepts the transfer DID 118, the second client device 109b can further include or reference the second account DID 112b within the transfer DID 118.

The second client device 109b can then send the transfer DID 118 to the second institution computing environment 103b. In some embodiments, the second institution computing environment 103b can verify that all the necessary information is provided in the transfer DID 118 to initiate a transfer. In some embodiments, the second institution computing environment 103b can validate the first VC 115a included or referenced with the transfer DID 118 to verify that the transfer can be made between the first institution computing environment 103a and the second institution computing environment 103b. The second institution computing environment 103b can then authorize the transfer between the second institution computing environment 103b and the first institution computing environment 103b. After the transfer being completed, the first institution computing environment 103a can revoke the first VC 115a, generate a new first VC 115a, and send the new first VC 115a to the first client device 109a. Also, after the transfer being completed, the second institution computing environment 103b can revoke the second VC 115b, generate a new second VC 115b, and send the new second VC 115b to the second client device 109b.

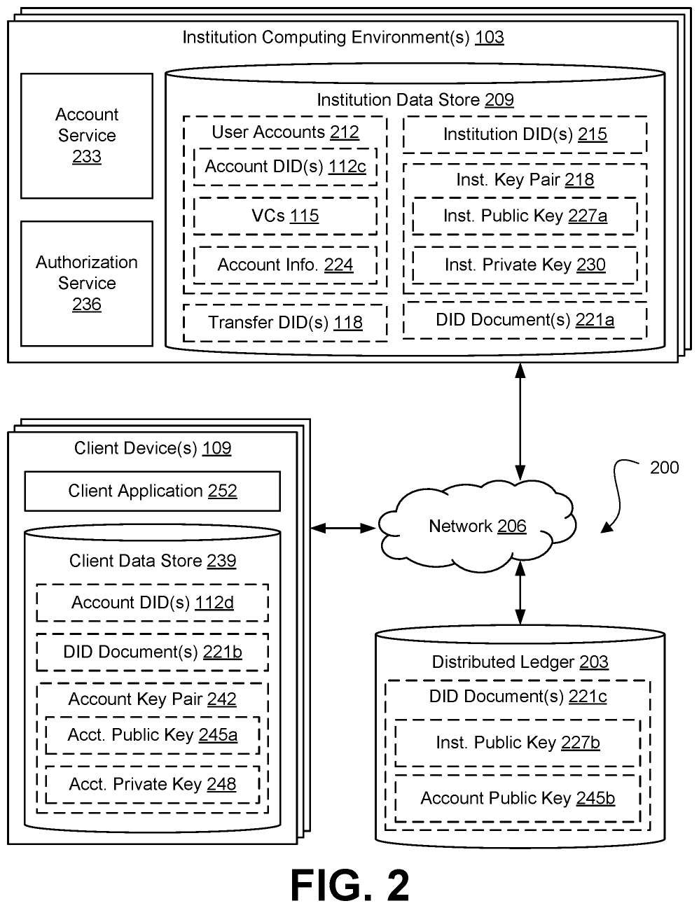

With reference to FIG. 2, shown is a network environment 200 according to various embodiments. The network environment 200 can include one or more institution computing environments 103 (e.g., the first institution computing environment 103a, the second institution computing environment 103b, etc.), one or more client devices 109 (e.g., the first client device 109a, the second client device 109b), and a distributed ledger 203, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

Each of the one or more institution computing environments 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, each of the one or more institution computing environments 103 can employ a plurality of computing devices that can be arranged in one or more server banks or computer banks or other arrangements. Such computing devices can be located in a single installation or can be distributed among many different geographical locations. For example, each of the one or more institution computing environments 103 can include a plurality of computing devices that together can include a hosted computing resource, a grid computing resource, or any other distributed computing arrangement. In some cases, some of the one or more institution computing environments 103 can correspond to an elastic computing resource where the allotted capacity of processing, network, storage, or other computing-related resources can vary over time.

Various data is stored in an institution data store 209 that is accessible to the one or more institution computing environments 103. The institution data store 209 can be representative of a plurality of institution data stores 209, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the institution data store 209 is associated with the operation of the various applications or functional entities described below. This data can include user accounts 212, institution DIDs 215, institution key pairs 218, transfer DIDs 118, DID Documents 221a, and potentially other data.

The user accounts 212 can represent user data stored in association other usages of an institution computing environment 103. For example, if the one or more institution computing environments 103 is an e-commerce platform, then the user profile 121 can include user data in relation to its e-commerce platform's usage. In at least some embodiments, the user accounts 212 can include an account balance, a credit limit, a purchasing power, or other financial information about the user 106. In at least another embodiment, the user accounts 212 can include a data transfer limit, an amount of data that is currently stored in the system, or other data related to data storage and data transfer. The user accounts can include account DIDs 112c, VCs 115, and account information 224.

The account DIDs 112c can correspond to an identifier that enables verifiable, decentralized digital identity of a specific account and/or a specific subject (e.g., person, organization, thing, etc.). In some examples, the account DID 112c can be used to represent the identity of a user 106, a client device 109, and/or other suitable subjects. In various examples, an account DID 112c can include an address to a DID document, such as the DID document 221a, DID document 221b, or DID document 221c. Any of the DID documents 221a, DID document 221b, or DID document 221c associated with the account DID 112c can include information associated with the subject (e.g., a user 106, a client device 109, etc.). Any of the DID documents 221a, DID document 221b, or DID document 221c associated with the account DID 112c can be hosted on any computing environment, such as the institution computing environment 103, client device 109, or any other computing environment, or any other distributed ledger 203. In some embodiments, Any of the DID documents 221a, DID document 221b, or DID document 221c associated with the account DID 112c can be shared peer-to-peer, rather than being shared from a centralized location. In various examples, the account DID 112c can be implemented using various standards, such as a version of the World Wide Web Consortium's (W3C's) Decentralized Identifier (DID) standard.

In at least some embodiments, the account DIDs 112c can be implemented as a peer DID. Peer decentralized identifiers (peer DIDs) are an extension of the traditional DID concept, such that it allows for the creation of DIDs without the need for an external blockchain or distributed ledger. Instead, peer DIDs are established and maintained directly between two or more parties, or peers, using a peer-to-peer (P2P) network. This approach eliminates the need for relying on a central registry or global consensus mechanism. Peer DIDs can be implemented using various standards, such as a version of the World Wide Web Consortium's (W3C's) peer DID method specification.

A verifiable credential (VC) 115 can represent a digital credential that has been issued by a third party, such as the institution computing environment 103. A VC 115 can include one or more claims about a subject, as represented by a DID, for which an issuer can attest. A VC 115 can represent all the same information that a physical credential represents. The addition of technologies, such as digital signatures, makes VCs 115 more tamper-evident and more trustworthy than their physical counterparts. In at least one embodiment, an institution computing environment 103 can issue a VC 115 that includes a purchasing power (e.g., a credit limit, a bank account balance, the sum thereof, etc.) for one or more accounts maintained by the institution computing environment 103. In at least another embodiment, an institution computing environment 103 can issue a VC 115 that includes a transfer limit (e.g., a data transfer limit, a maximum data quota, etc.) for one or more accounts maintained by the institution computing environment 103. A VC 115 can be used to derive verifiable presentations, which are tamper-evident presentations encoded in such a way that the source of the data can be trusted after a process of verification. The verifiable presentations are synthesized in such a way that the VC 115 cannot be recreated from the verifiable presentation alone. Verifiable credentials 115 and verifiable presentations can be implemented using various standards, such as a version of the World Wide Web Consortium's (W3C's) verifiable credentials (VC) data model standard.

The account information 224 can represent various types of information about a user 106 and their respective accounts held in the institution data store 209. The account information 224 can represent personal data associated with a user, name, address, contact information, transaction information (e.g., transaction confirmation, payment instruments, etc.), healthcare information, and other suitable user data. The account information 224 can be used to identify a person or an entity associated with a DID 124. Additionally, the account information 224 can include information about a user's financial accounts or business record accounts. For instance, the account information 224 can include a purchasing power (e.g., a credit limit, a bank account balance, the sum thereof, etc.) for one or more accounts maintained by the institution computing environment 103. In at least another embodiment, the account information 224 can include a transfer limit (e.g., a data transfer limit, a maximum data quota, etc.) for one or more accounts maintained by the institution computing environment 103.

The institution DIDs 215 can correspond to an identifier that enables verifiable, decentralized digital identity of a specific internet service providers (ISPs) (e.g., VPN providers, internet providers, wireless phone providers, etc.), internet data storage providers (e.g., cloud storage providers, etc.), financial institutions (e.g., banks, credit card providers, etc.) and/or a specific subject (e.g., person, organization, thing, etc.). In some examples, the institution DIDs 215 can be used to represent an institution computing environment 103. In various examples, an institution DIDs 215 can include an address to a DID document, such as the DID document 221a or DID document 221c. Any of the DID documents 221a or DID document 221c associated with the institution DIDs 215 can include information associated with the subject (e.g., an institution computing environment 103, etc.). Any of the DID documents 221a or DID document 221c associated with the institution DIDs 215 can be hosted on the institution computing environment 103, any other computing environment, or a distributed ledger 203. In some embodiments, Any of the DID documents 221a or DID document 221c associated with the institution DIDs 215 can be shared peer-to-peer, rather than being shared from a centralized location. In various examples, the institution DIDs 215 can be implemented using various standards, such as a version of the World Wide Web Consortium's (W3C's) Decentralized Identifier (DID) standard. In at least some embodiments, the institution DIDs 215 can be implemented as a peer DID. Peer DIDs can be implemented using various standards, such as a version of the World Wide Web Consortium's (W3C's) peer DID method specification. In such an embodiment, the one or more institution computing environments 103 can identify each other and share their respective institution DIDs 215, as well as any other information, without having to involve a centralized repository, such as a distributed ledger 203.

The institution key pair 218 can represent a pair of asymmetric cryptographic keys comprising an institution public key 227a (generically as 227) and institution private key 230. The institution public key 227 can be used to cryptographically encrypt messages. The institution private key 230 can be used to cryptographically decrypt messages that have been encrypted by the issuer public key 227. The institution private key 230 can be used to cryptographically sign various items, such as VCs 115 or various messages. The institution public key 227 can be used to cryptographically verify that something (e.g., VCs 130, a message, etc.) is cryptographically signed by the institution private key 230. In at least some embodiments, the institution key pair 218 can be associated with an institution DID 215. In such an embodiment, the institution DID 215 can provide a reference to an institution public key 227a through a DID document 221a.

The transfer DID 118 can represent a transfer of information (e.g., data, currency, etc.) rather than an identity of a user 106, institution, or their respective computing devices. For example, a transfer DID 118 can represent a financial transaction between two parties. In another example, a transfer DID 118 can represent a data transfer between two computing devices. In various examples, a transfer DID 118 can include an address to a DID document, such as the DID document 221a, DID document 221b, or DID document 221c. Any of the DID documents 221a, DID document 221b, or DID document 221c associated with the transfer DID 118 can include information associated with the transfer. Any of the DID documents 221a, DID document 221b, or DID document 221c associated with the account DID 112c can be hosted on any computing environment, such as the institution computing environment 103, client device 109, or any other computing environment, or any other distributed ledger 203. In some embodiments, any of the DID documents 221a, DID document 221b, or DID document 221c associated with transfer DID 118 can be shared peer-to-peer, rather than being shared from a centralized location. In various examples, the transfer DIDs 118 can be implemented using various standards, such as a version of the World Wide Web Consortium's (W3C's) Decentralized Identifier (DID) standard. In at least some embodiments, the transfer DIDs 118 can be implemented as a peer DID. Peer DIDs can be implemented using various standards, such as a version of the World Wide Web Consortium's (W3C's) peer DID method specification.

The DID documents 221a (generically as DID documents 221) can includes information associated with a subject (e.g., user, transaction, device, etc.). For example, the DID document 221a can include a set of data describing the subject and can include various information (e.g., cryptographic keys) that can be used to identify and authenticate the subject. In at least one example, the DID document 221a can include various public keys, such as the institution public key 227b or the account public key 245b, as shown in the DID document 221c. In various examples, the DID document 221a can be implemented using various standards, such as the World Wide Web Consortium's (W3C's) Decentralized Identifier (DID) standard.

Also, various applications or other functionality can be executed in each of the one or more institution computing environments 103. The components executed on each of the one or more institution computing environments 103 include an account service 233, an authorization service 236, and other applications, services, processes, systems, engines, or functionality not discussed in detail herein.

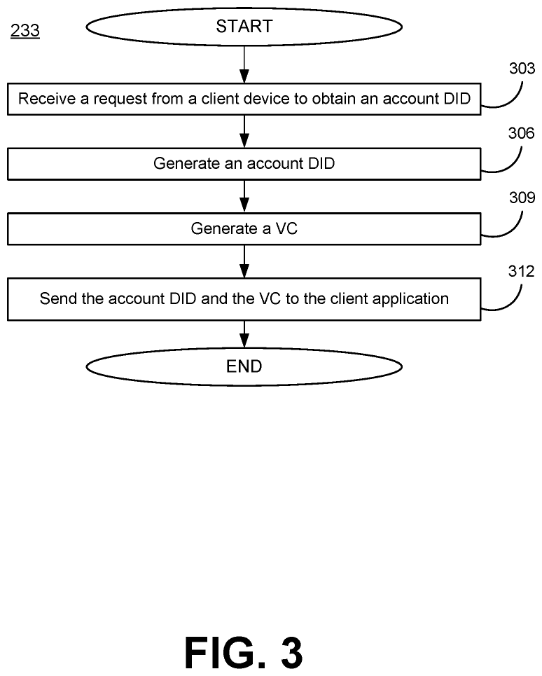

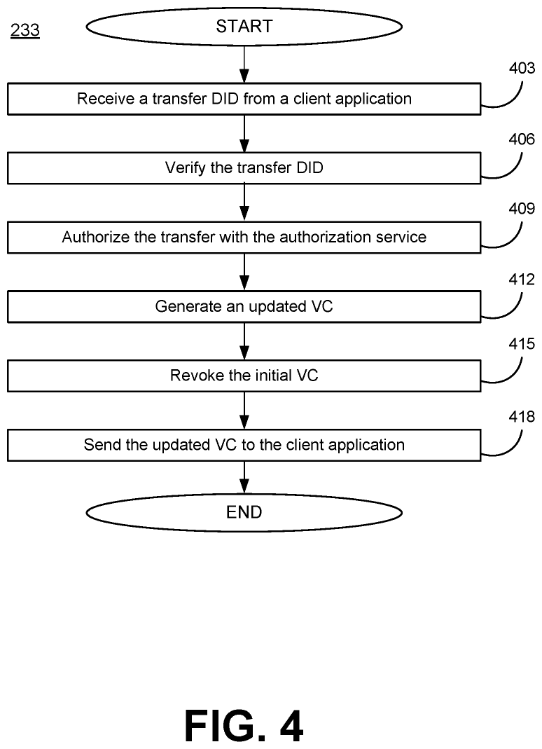

The account service 233 can be executed to perform various actions. For example, the account service 233 can receive a request to obtain an account DID 112. The account service 233 can also generate an account DID 112 and/or a VC 115 and send the account DID 112 and/or a VC 115 to a client device 109. The account service 233 can also receive a transfer DID 118 from a client application 252, which the account service 233 can verify. The account service 233 can also authorize a transfer with the authorization service 236. The account service 233 can generate an updated VC 115, revoke the initial VC 115, and send the updated VC 115 to the client application 252 on the client device 109. Additional descriptions of actions that can be executed by the account service 233 will be further described in the discussion of FIGS. 3 and 4.

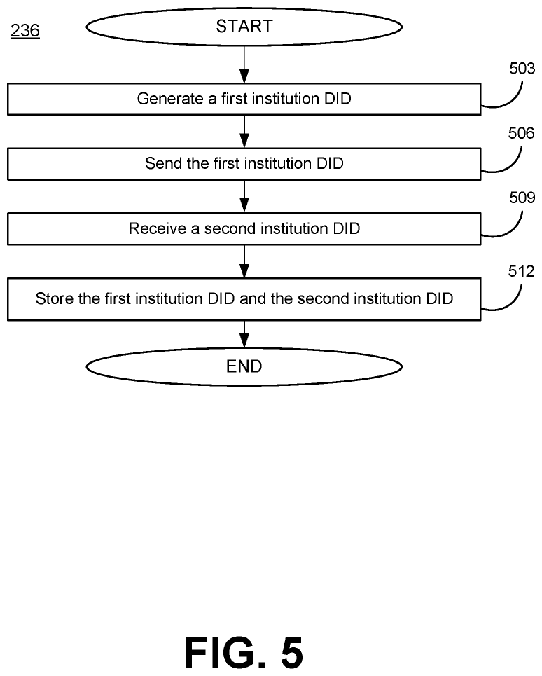

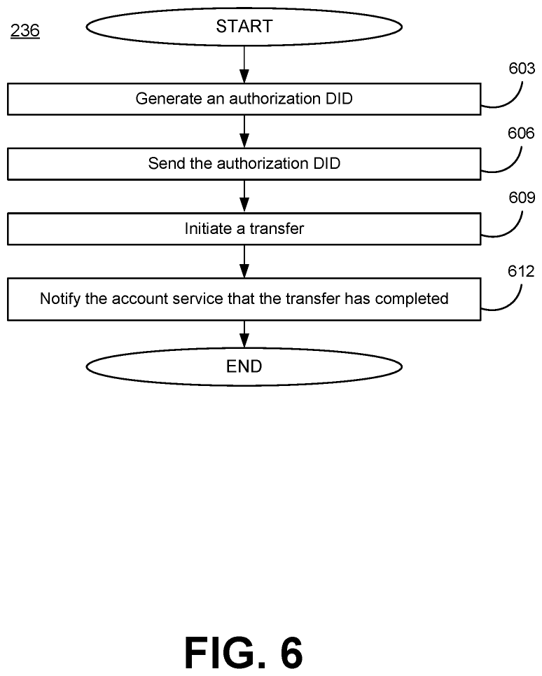

The authorization service 236 can be executed to perform various functions. For instance, the authorization service 236 can be executed to generate a first institution DID 215, send the first institution DID 215 to a second institution computing environment 103, receive a second institution DID 215 from the second institution computing environment 103, and store both the first institution DID 215 and the second institution DID 215 in the institution data store 209. Additionally, the authorization service 236 can generate an authorization DID, which is a specialized transfer DID 118 that is shared between institution computing environments 103. The authorization service 236 can send the authorization DID to another institution computing environment 103 and subsequently initiate the transfer. Once the transfer has completed, the authorization service 236 can notify the account service 233 that the transfer has completed. Additional descriptions of actions that can be executed by the authorization service 236 will be further described in the discussion of FIGS. 5 and 6.

The client device 109 can be representative of a plurality of client devices that can be coupled to the network 206. Each client device 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 109 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 109 or can be connected to the client device 109 through a wired or wireless connection.

Various data is stored in a client data store 239 that is accessible to the client device 109. The client data store 239 can be representative of a plurality of client data stores 239, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the client data store 239 is associated with the operation of the various applications or functional entities described below. This data can include account DIDs 112d, DID documents 221b, account key pairs 242, and potentially other data.

The account DIDs 112d can correspond to an identifier that enables verifiable, decentralized digital identity of a specific account and/or a specific subject (e.g., person, organization, thing, etc.). In some examples, the account DID 112d can be used to represent the identity of a user 106, a client device 109, and/or other suitable subjects. In various examples, an account DID 112d can include an address to a DID document, such as the DID document 221a, DID document 221b, or DID document 221c. Any of the DID documents 221a, DID document 221b, or DID document 221c associated with the account DID 112d can include information associated with the subject (e.g., a user 106, a client device 109, etc.). Any of the DID documents 221a, DID document 221b, or DID document 221c associated with the account DID 112d can be hosted on any computing environment, such as the institution computing environment 103, client device 109, or any other computing environment, or any other distributed ledger 203. In some embodiments, Any of the DID documents 221a, DID document 221b, or DID document 221c associated with the account DID 112d can be shared peer-to-peer, rather than being shared from a centralized location. In various examples, the account DID 112d can be implemented using various standards, such as a version of the World Wide Web Consortium's (W3C's) Decentralized Identifier (DID) standard. In at least some embodiments, the account DIDs 112d can be implemented as a peer DID. Peer DIDs can be implemented using various standards, such as a version of the World Wide Web Consortium's (W3C's) peer DID method specification. In at least some embodiments, the account DID 112d can match the account DID 112c on the institution computing environment 103.

The DID documents 221b (generically as DID documents 221) can includes information associated with a subject (e.g., user, transaction, device, etc.). For example, the DID document 221b can include a set of data describing the subject and can include various information (e.g., cryptographic keys) that can be used to identify and authenticate the subject. In at least one example, the DID document 221b can include various public keys, such as the institution public key 227b or the account public key 245b, as shown in the DID document 221c. In various examples, the DID document 221b can be implemented using various standards, such as the World Wide Web Consortium's (W3C's) Decentralized Identifier (DID) standard.

The account key pair 242 can represent a pair of asymmetric cryptographic keys comprising an account public key 245a (generically as 245) and account private key 248. The account public key 245 can be used to cryptographically encrypt messages. The account private key 248 can be used to cryptographically decrypt messages that have been encrypted by the issuer public key 245. The account private key 248 can be used to cryptographically sign various items, such as VCs 115 or various messages. The account public key 245 can be used to cryptographically verify that something (e.g., VCs 130, a message, etc.) is cryptographically signed by the account private key 248.

The client device 109 can be configured to execute various applications such as a client application 252 or other applications. The client application 252 can be executed in a client device 109 to access network content served up by the one or more institution computing environments 103 or other servers, thereby rendering a user interface on the display. To this end, the client application 252 can include a browser, a dedicated application, or other executable, and the user interface can include a network page, an application screen, or other user mechanism for obtaining user input. The client device 109 can be configured to execute applications beyond the client application 252, such as email applications, social networking applications, word processors, spreadsheets, or other applications.

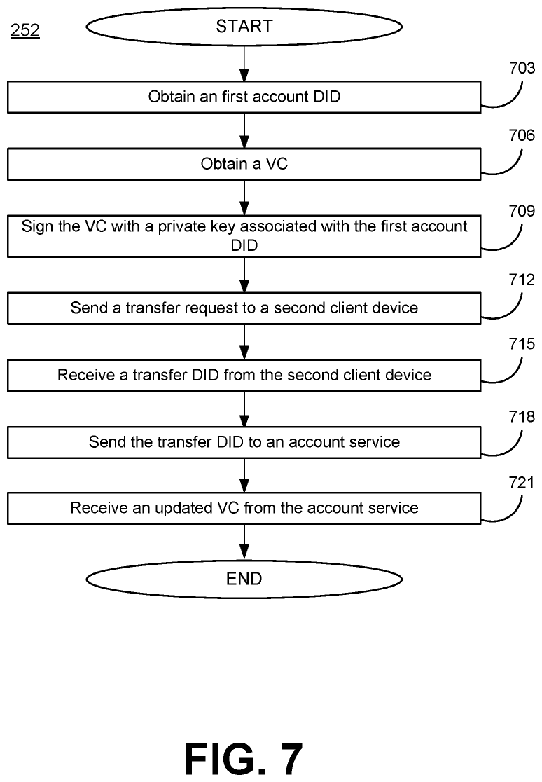

The client application 252 can be executed to perform various actions. For example, the client application 252 can be executed to obtain a first account DID 112 and a first VC 115. The client application 252 can sign the first VC 115 with an account private key 248. The client application 252 can obtain information send a transfer request to a second client device that includes instructions about a specified transfer. In response, the client application 252 can receive a transfer DID 118 from the client application 252 of the second client device 109 that includes the instructions about the transfer. The client application 252 can verify the information in the transfer DID 118 and then send the transfer DID 118 to an account service 233 hosted on an institution computing environment 103. If the transfer is completed, the client application 252 can receive a second VC from the account service 233 because the first VC 115 will have been revoked. In another embodiment, the client application 252 can obtain a transfer request from a second client device 109. In such an embodiment, the client application 252 can generate a transfer DID 118 and send the transfer DID to the second client device 109. Additional descriptions of actions that can be executed by the client application 252 will be further described in the discussion of FIGS. 7, 8, 10, and 11.

The distributed ledger 203 can represent one or more synchronized, eventually consistent, data stores spread across multiple nodes in different geographic or network locations. Each node in the distributed ledger 203 can contain a replicated copy of the distributed ledger 203, including all data stored in the distributed ledger 203. Records of transactions involving the distributed ledger 203 can be shared or replicated using a peer-to-peer network connecting the individual nodes that form the distributed ledger 203. Once a transaction or record is recorded in the distributed ledger 203, it can be replicated across the peer-to-peer network until the record is eventually recorded with all nodes.

The distributed ledger 203 can include DID document(s) 221c, which include one or more public keys, such as an institution public key 227b, an account public key 245b, and other suitable data. In various examples, any DID (e.g., account DIDs 112d, institution DIDs 215, transfer DIDS 118) can correspond to an address to a DID document 221c that includes information associated with a subject (e.g., user, transaction, transfer, device, etc.). For example, the DID document 221c can include a set of data describing the subject and can include various information (e.g., cryptographic keys) that can used to authenticate the subject. In at least one example, the DID document 221c can include various public keys, such as an institution public key 227b and an account public key 245b. In various examples, the DID document 221c can be implemented using various standards, such as the World Wide Web Consortium's (W3C's) Decentralized Identifier (DID) standard. The institution public key 227b can be otherwise identical to the institution public key 227a, except stored in distributed ledger 203 rather than institution data store 209. The account public key 245b can be otherwise identical to the account public key 245a, except stored in distributed ledger 203 rather than client data store 239.

Referring next to FIG. 3, shown is a flowchart that provides one example of the operation of a portion of the account service 233. The flowchart of FIG. 3 provides merely an example of the many different types of functional arrangements that can be employed to implement the operation of the depicted portion of the account service 233. As an alternative, the flowchart of FIG. 3 can be viewed as depicting an example of elements of a method implemented within the network environment 200.

Beginning with block 303, the account service 233 can receive a request to obtain an account DID 112. In various embodiments, the request to obtain the account DID 112 can be sent from a client application 252 running on a client device 109. In at least some embodiments, the request to obtain an account DID 112 can include various personal information and/or account information 224. The personal information and/or account information 224 can be used to identify a user account 212 that includes one or more account DIDs 112c. In some embodiments, the request to obtain an account DID 112 can include an account public key 245. If an account DID 112 already exists in the user account 212, then the flowchart can continue to block 309, otherwise the flowchart can continue to block 306.

Continuing to block 306, the account service 233 can generate an account DID 112. To generate an account DID 112, the account service 233 can first generate a DID document 221 that includes various information to represent the identity of a user 106, a client device 109, and/or other suitable subjects. Information can include the account information 224 and/or any information stored in the user account 212. Additionally, the DID document 221 can include the account public key 245 sent along with the request to obtain the account DID 112 at block 303 or an account public key 245 that is publicly accessible and associated with the user account 212. The DID document 221 can be stored in the institution data store 209 or the distributed ledger 203. Once, the DID document 221 has been generated, the account DID 112 can be generated to reference the DID document 221 according to at least one of the World Wide Web Consortium's (W3C's) Decentralized Identifier (DID) standard or the Identity Foundation's peer DID standard.

Next, at block 309, the account service 233 can generate a VC 115. The account service 233 can generate the VC 115 to provide one or more claims about the associated account DID 112. For instance, the account service 233 can generate a VC 115 that includes a claim about a purchasing power (e.g., a credit limit, a bank account balance, the sum thereof, etc.) for one or more accounts associated with the user account 212 and the account DID 112. In at least another embodiment, the account service 233 can generate a VC 115 that includes a claim about a transfer limit (e.g., a data transfer limit, a maximum data quota, etc.) for one or more accounts associated with the user account 212 and the account DID 112. The VC 115 can be signed by the institution private key 230.

Continuing to block 312, the account service 233 can send the account DID 112 and/or the VC 115. In various embodiments, the account service 233 can send the account DID 112 and/or the VC 115 to the client application 252 on the client device 109. In at least one embodiment, the account service 233 can send each of the account DID 112 and the VC 115 individually in their own responses. In at least another embodiment, the account service 233 can send both the account DID 112 and the VC 115 together to the client application 252 on the client device 109. Once block 312 has completed, the flowchart of FIG. 3 can come to an end.

Referring next to FIG. 4, shown is a flowchart that provides one example of the operation of a portion of the account service 233. The flowchart of FIG. 4 provides merely an example of the many different types of functional arrangements that can be employed to implement the operation of the depicted portion of the account service 233. As an alternative, the flowchart of FIG. 4 can be viewed as depicting an example of elements of a method implemented within the network environment 200.

Beginning with block 403, the account service 233 can receive a transfer DID 118 from a client application 252. In various examples, a transfer DID 118 can include an address to a DID document, such as the DID document 221a, DID document 221b, or DID document 221c. The transfer DID 118 or its corresponding DID document 221 can include instructions on how to perform a transfer. In at least some embodiments, a transfer DID 118 can represent a financial transaction between two parties. In at least another embodiment, a transfer DID 118 can represent a data transfer between two computing devices. The transfer DID 118 or its corresponding DID document 221 can include information that identifies an account DID 112 associated with a user account 212 on an institution computing environment 103 from which the transfer is being sent, an account DID 112 associated with a user account 212 on an institution computing environment 103 to which the transfer is being sent, a transfer subject (e.g., an amount to transfer, one or more files to be transferred, etc.), one or more VCs 115, and various other information. In some embodiments, the transfer DID 118 itself can be received along with one or more DID documents 221.

Continuing to block 406, the account service 233 can verify the transfer DID 118. In at least one embodiment, the account service 233 can verify that institution computing environment 103 can access any necessary information, such as DID documents 221, other institution computing environments 103, and/or the respective client devices 109. In some embodiments, the account service 233 can validate a VC 115 or a verifiable presentation that is associated with the transferor to ensure that the transfer can be successfully completed. For example, if the transfer DID 118 represents a financial transaction between a transferor and a transferee, the account service 233 can validate a VC 115 or verifiable presentation associated with the transferor that includes a claim that the transferor has the necessary purchasing power to make the payment. In another example, if the transfer DID 118 represents a data transfer between a transferor and a transferee, the account service 233 can validate a VC 115 or verifiable presentation associated with the transferor that includes a claim that the transferor has the necessary files, has the bandwidth to make such a transfer, or has not met a transfer data quota. Additionally, the account service 233 can verify that the VC 115 has not been revoked by the issuer. The account service 233 can validate the VC 115 in various ways, as further described in various standards, such as a version of the World Wide Web Consortium's (W3C's) verifiable credentials (VC) data model standard. If verifying the transfer DID 118 fails for any reason, the client application 252 can be notified of the failure to complete the transfer and the process of FIG. 4 can come to an end. If verifying the transfer DID 118 produces no errors or failures in validation, then the process can continue to block 409.

Next, at block 409, the account service 233 can authorize a transfer with the authorization service 236. In at least some embodiments, the account service 233 can send instructions to the authorization service to initiate a transfer between a transferor and a transferee. The account service 233 can generate the instructions based on the contents of the transfer DID 118. For example, the transfer DID 118 can include a detail about transferring an amount of currency between a first bank account at a first financial institution to a second bank account at a second financial institution. Based on that information, the account service 233 can generate the necessary instructions for the authorization service 236 to initiate the transfer of the amount of currency between the first bank account at a first financial institution to the second bank account at the second financial institution. In some embodiments, the account service 233 can forwards the transfer DID 118 to the authorization service 236. In some embodiments, the authorization service 236 can then perform the process described in FIG. 6. In some embodiments, the authorization service 236 can provide a response that signifies whether the transfer has been completed. If the transfer failed for any reason, the account service 233 can notify the client application 252 and the process of FIG. 4 can come to an end. However, if the transfer is completed, the account service 233 can continue to block 412.

At block 412, the account service 233 can generate an updated VC 115. The account service 233 can generate the updated VC 115 to provide one or more claims about the associated account DID 112 subsequent to authorizing the transfer. For instance, the account service 233 can generate an updated VC 115 that includes a claim about an updated purchasing power (e.g., a credit limit, a bank account balance, the sum thereof, etc.) that considers any modifications (e.g., increases, decreases, etc.) to such a purchasing power. In at least another embodiment, the account service 233 can generate an updated VC 115 that includes a claim about a transfer limit (e.g., a data transfer limit, a maximum data quota, etc.) that considers any modifications (e.g., increases, decreases, etc.) to such a transfer limit. The updated VC 115 can be signed by the institution private key 230.

Next, at block 415, the account service 233 can revoke the initial VC 115. To ensure that the initial VC 115 cannot be used to validate subsequent transfers, the account service 233 can revoke the initial VC 115. The account service 233 can revoke the initial VC 115 as further described in various standards, such as a version of the World Wide Web Consortium's (W3C's) verifiable credentials (VC) data model standard. Finally, at block 418, the account service 233 can send the updated VC 115 to the client application 252 on the client device 109. Once block 418 has completed, the process of FIG. 4 can come to an end.

Referring next to FIG. 5, shown is a flowchart that provides one example of the operation of a portion of the authorization service 236. The flowchart of FIG. 5 provides merely an example of the many different types of functional arrangements that can be employed to implement the operation of the depicted portion of the authorization service 236. As an alternative, the flowchart of FIG. 5 can be viewed as depicting an example of elements of a method implemented within the network environment 200.

Beginning with block 503, the authorization service 236 can generate a first institution DID 215. The institution DIDs 215 can correspond to an identifier that enables verifiable, decentralized digital identity of a specific internet service providers (ISPs) (e.g., VPN providers, internet providers, wireless phone providers, etc.), internet data storage providers (e.g., cloud storage providers, etc.), financial institutions (e.g., banks, credit card providers, etc.) and/or a specific subject (e.g., person, organization, thing, etc.). In some examples, the institution DIDs 215 can be used to represent an institution computing environment 103. To generate first institution DID 215, the authorization service 236 can first generate a DID document 221 that includes various information to represent the identity institution, the institution computing environment 103, and/or other suitable subjects. Additionally, the DID document 221 can include the institution public key 230 associated with the institution computing environment 103. The DID document 221 can be stored in the institution data store 209 or the distributed ledger 203. Once, the DID document 221 has been generated, the first institution DID 215 can be generated to reference the DID document 221 according to at least one of the World Wide Web Consortium's (W3C's) Decentralized Identifier (DID) standard or the Identity Foundation's peer DID standard.

Continuing to block 506, the authorization service 236 can send the first institution DID 215 to a second institution computing environment 103. By sending the first institution DID 215 to a second institution computing environment 103, a peer connection can be established between the first institution computing environment 103 and a second institution computing environment 103. Further, by the second institution computing environment 103 obtaining the first institution DID 215, the second institution computing environment 103 can verify that VCs 115 that were issued by the first institution computing environment 103 are valid by using the institution public key 227 that is included.

Similarly, at block 509, the authorization service 236 can receive a second institution DID 215 from the second institution computing environment 103. By receiving the second institution DID 215 from a second institution computing environment 103, a peer connection can be established between the first institution computing environment 103 and a second institution computing environment 103. Further, by obtaining the second institution DID 215, the first institution computing environment 103 can verify that VCs 115 that were issued by the second institution computing environment 103 are valid by using the associated institution public key 227. Finally, at block 512, the authorization service 236 can store the first institution DID 215 and the second institution DID 215 in the institution data store 209. Once block 512 has completed, the flowchart of FIG. 5 can come to an end.

Referring next to FIG. 6, shown is a flowchart that provides one example of the operation of a portion of the authorization service 236. The flowchart of FIG. 6 provides merely an example of the many different types of functional arrangements that can be employed to implement the operation of the depicted portion of the authorization service 236. As an alternative, the flowchart of FIG. 6 can be viewed as depicting an example of elements of a method implemented within the network environment 200.

Beginning with block 603, the authorization service 236 can generate an authorization DID. An authorization DID is a specialized instance of a transfer DID 118 that is shared between at least a first institution computing environment 103 and a second institution computing environment 103. The authorization DID can be stored in each of the respective institution data stores 209 to maintain a record of the transfer. In at least some embodiments, the authorization service 236 can generate the authorization DID in response to receiving instructions to perform a transfer and/or a transfer DID 118 from an account service 233. The authorization DID can include various information about the transfer, such as account information 224, information that identifies the user accounts 212, a subject of the transfer (e.g., currency, data, etc.), and various other information. Subsequently, at block 606, the authorization service 236 can send the authorization DID to a second institution computing environment 103. In at least some embodiments, the process can continue after the authorization DID has been sent to the second institution computing environment 103.

Next, at block 609, the authorization service 236 can initiate the transfer between the first institution computing environment 103 and the second institution computing environment 103. In at least some embodiments where the transfer can be a financial transaction, the first institution computing environment 103 can initiate a transaction over traditional channels, such as Automated Clearing House (ACH), real-time payment (RTP) channels, Society for Worldwide Interbank Financial Telecommunication (SWIFT), PayPal®, blockchain payment channels, or other similar payment channels. In at least some embodiments where the transfer can be a data transfer, the first institution computing environment 103 can initiate the transfer using over various channels, like an FTP/SFTP connection, email, peer-to-peer file sharing, a virtual private network tunnel, and/or various other network channels.

Continuing to block 612, the authorization service 236 can notify the account service 233 that the transfer has completed. In at least some embodiments, the authorization service 236 will receive a notification from the second institution computing environment 103 that the transfer has been completed. In such an embodiment, the authorization service 236 can provide the notification to the account service 233 in response to receiving the notification from the second institution computing environment 103. Once block 612 has completed, the flowchart of FIG. 6 can come to an end.

Referring next to FIG. 7, shown is a flowchart that provides one example of the operation of a portion of the client application 252. The flowchart of FIG. 7 provides merely an example of the many different types of functional arrangements that can be employed to implement the operation of the depicted portion of the client application 252. As an alternative, the flowchart of FIG. 7 can be viewed as depicting an example of elements of a method implemented within the network environment 200.

Beginning with block 703, the client application 252 can obtain a first account DID 112. In at least some embodiments, the client application 252 can obtain a first account DID 112 from a first institution computing environment 103. The client application 252 can send a request to obtain an account DID to the account service 233 of the first institution computing environment 103. In at least some embodiments, the request to obtain the first account DID 112 can include various personal information and/or account information 224. The personal information and/or account information 224 can be used to identify a user account 212 that includes one or more account DIDs 112c. In some embodiments, the request to obtain the first account DID 112 can include an account public key 245. The client application 252 can receive the requested account DID 112 from the first institution computing environment 103.

Continuing to block 706, the client application 252 can obtain a first VC 115. In at least some embodiments, the client application 252 can request a first VC from an account service 233 of a first institution computing environment 103. In response, the account service 233 of the first institution computing environment 103 can send a first VC 115. In at least another embodiment, the account service 233 of the first institution computing environment can receive the first VC 115 without having to send a request. The first VC 115 can include one or more claims about the associated account identified by the account DID 112. For instance, the account service 233 can generate a first VC 115 that includes a claim about a purchasing power (e.g., a credit limit, a bank account balance, the sum thereof, etc.) for one or more accounts associated with the user account 212 and the account DID 112. In at least another embodiment, the account service 233 can generate a first VC 115 that includes a claim about a transfer limit (e.g., a data transfer limit, a maximum data quota, etc.) for one or more accounts associated with the user account 212 and the account DID 112. The first VC 115 can be signed by the institution private key 230.

Next, at block 709, the client application 252 can sign the first VC 115 with a private key associated with the first account DID 112. In at least some embodiments, the client application 252 can sign the first VC 115 with the account private key 248, which can be associated with the first account DID 112. By signing the first VC 115, the client application 252 is co-signing that the claims described in the first VC 115 are true. In at least some embodiments, the first VC 115 can be signed by both the institution private key 230 as well as the account private key 248, which indicates that both the institution and the user can allege the validity of the claim is true.

Continuing to block 712, the client application 252 can send a transfer request to a client application 252 of a second client device 109. In at least one embodiment, the transfer request can include the first account DID 112, the first VC 115, network information about the client device 109, information about the transfer (e.g., a transaction amount, files to transfer, etc.), and various other information. The transfer request can act as an offer sent by the first client device 109 to the second client device 109, which the second client device 109 can subsequently provide the necessary acceptance by generating a transfer DID 118 and returning the transfer DID 118 the first client device 109. In at least some embodiments, the transfer request can be sent through various channels, such as email, SMS messages, Bluetooth, and/or other various messaging channels. In some embodiments, the transfer request can be transformed into a matrix barcode that can be displayed by the first client device 109 for consumption by the second client device 109.

Next, at block 715, the client application 252 can receive a transfer DID 118 from the second client device 109. In various examples, a transfer DID 118 can include an address to a DID document, such as the DID document 221a, DID document 221b, or DID document 221c. The transfer DID 118 or its corresponding DID document 221 can include instructions on how to perform a transfer. In at least some embodiments, a transfer DID 118 can represent a financial transaction between two parties. In at least another embodiment, a transfer DID 118 can represent a data transfer between two computing devices. The transfer DID 118 or its corresponding DID document 221 can include information that identifies information related to the transferor (e.g., an account DID 112, a did document 221, account info 224, etc.), information related to the transferee (e.g., an account DID 112, a did document 221, account info 224, etc.), a transfer subject (e.g., an amount to transfer, one or more files to be transferred, etc.), one or more VCs 115, and various other information. In some embodiments, the transfer DID 118 itself can be received along with one or more DID documents 221.

Continuing to block 718, the client application 252 can send the transfer DID 118 to the account service 233 of the first institution computing environment 103. In at least one embodiment, the client application 252 can forward the transfer DID 118 to the account service 233 of the first institution computing environment 103. In some embodiments, the client application 252 can first validate or verify information in the transfer DID prior to sending the transfer DID 118 to the account service 233 of the first institution computing environment 103.

Continuing to block 721, the client application 252 can receive a second VC 115. The account service 233 of the first institution computing environment can receive the second VC 115 without having to send a request. In some embodiments, the second VC 115 can be received in response to the transfer being completed. In at least another embodiment, the second VC 115 can be received when information about the user accounts 212 has been changed. The second VC 115 can include one or more updated claims about the associated account identified by the account DID 112. For instance, the account service 233 can generate the second VC 115 having an updated claim about the purchasing power (e.g., a credit limit, a bank account balance, the sum thereof, etc.) for one or more accounts associated with the user account 212 and the account DID 112. The purchasing power can be modified (e.g., increased, decreased, etc.) as a result of the transfer being completed. In at least another embodiment, the account service 233 can generate second VC 115 that includes a claim about a transfer limit (e.g., a data transfer limit, a maximum data quota, etc.) for one or more accounts associated with the user account 212 and the account DID 112. The second VC 115 can be signed by the institution private key 230. Once block 721 has completed, the flowchart of FIG. 7 can come to an end.

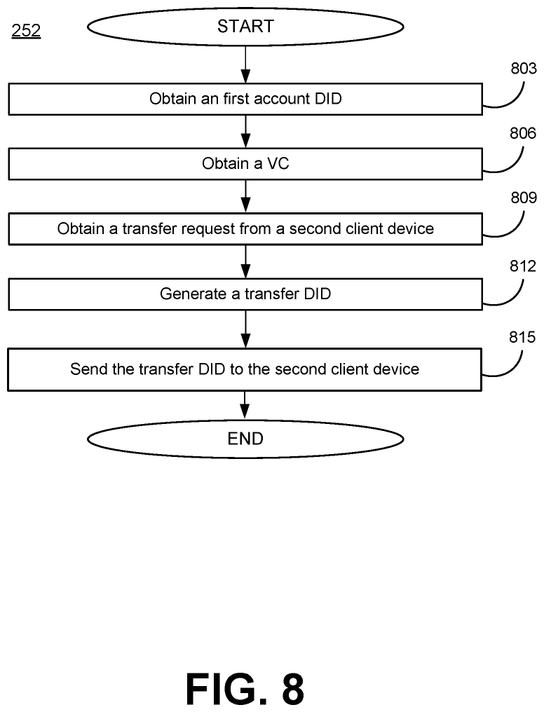

Referring next to FIG. 8, shown is a flowchart that provides one example of the operation of a portion of the client application 252. The flowchart of FIG. 8 provides merely an example of the many different types of functional arrangements that can be employed to implement the operation of the depicted portion of the client application 252. As an alternative, the flowchart of FIG. 8 can be viewed as depicting an example of elements of a method implemented within the network environment 200.

Beginning with block 803, the client application 252 can obtain a first account DID 112. In at least some embodiments, the client application 252 can obtain a first account DID 112 from a first institution computing environment 103. The client application 252 can send a request to obtain an account DID to the account service 233 of the first institution computing environment 103. In at least some embodiments, the request to obtain the first account DID 112 can include various personal information and/or account information 224. The personal information and/or account information 224 can be used to identify a user account 212 that includes one or more account DIDs 112c. In some embodiments, the request to obtain the first account DID 112 can include an account public key 245. The client application 252 can receive the requested account DID 112 from the first institution computing environment 103.

Continuing to block 806, the client application 252 can obtain a first VC 115. In at least some embodiments, the client application 252 can request a first VC from an account service 233 of a first institution computing environment 103. In response, the account service 233 of the first institution computing environment 103 can send a first VC 115. In at least another embodiment, the account service 233 of the first institution computing environment can receive the first VC 115 without having to send a request. The first VC 115 can include one or more claims about the associated account identified by the account DID 112. For instance, the account service 233 can generate a first VC 115 that includes a claim about a purchasing power (e.g., a credit limit, a bank account balance, the sum thereof, etc.) for one or more accounts associated with the user account 212 and the account DID 112. In at least another embodiment, the account service 233 can generate a first VC 115 that includes a claim about a transfer limit (e.g., a data transfer limit, a maximum data quota, etc.) for one or more accounts associated with the user account 212 and the account DID 112. The first VC 115 can be signed by the institution private key 230.

Next, at block 809, the client application 252 can obtain a transfer request from a second client device 109. In at least one embodiment, the transfer request can include a second account DID 112, a second VC 115, network information about the second client device 109, information about the transfer (e.g., a transaction amount, files to transfer, etc.), and various other information. The transfer request can act as an offer sent by the first client device 109 to the second client device 109, which the second client device 109 can subsequently provide the necessary acceptance by generating a transfer DID 118 and returning the transfer DID 118 the first client device 109. In at least some embodiments, the transfer request can be sent through various channels, such as email, SMS messages, Bluetooth, and/or other various messaging channels. In some embodiments, the transfer request can be transformed into a matrix barcode that can be displayed by the first client device 109 for consumption by the second client device 109.

Continuing to block 812, the client application 252 can generate a transfer DID 118. The transfer DID 118 can represent a transfer of information (e.g., data, currency, etc.) rather than an identity of a user 106, institution, or their respective computing devices. For example, a transfer DID 118 can represent a financial transaction between two parties. In another example, a transfer DID 118 can represent a data transfer between two computing devices. In various examples, a transfer DID 118 can include an address to a DID document, such as the DID document 221a, DID document 221b, or DID document 221c. The DID document 221 associated with the transfer DID 118 can include information associated with the transfer, like the first account DID 112, the first VC 115, any of the information received at block 809 in the transfer request that was received, and various other information. The DID document 221 associated with the transfer DIDs 118 can be hosted on any computing environment, such as the institution computing environment 103, client device 109, or any other computing environment, or any other distributed ledger 203. In some embodiments, any of the DID documents 221a, DID document 221b, or DID document 221c associated with transfer DID 118 can be shared peer-to-peer, rather than being shared from a centralized location. In various examples, the transfer DIDs 118 can be implemented using various standards, such as a version of the World Wide Web Consortium's (W3C's) Decentralized Identifier (DID) standard. In at least some embodiments, the transfer DIDs 118 can be implemented as a peer DID. Peer DIDs can be implemented using various standards, such as a version of the World Wide Web Consortium's (W3C's) peer DID method specification.

Next, at block 815, the client application 252 can send the send the transfer DID 118 to the second client device 109. In at least some embodiments, the transfer DID 118 can be sent through various channels, such as email, SMS messages, Bluetooth, and/or other various messaging channels. In some embodiments, the transfer DID 118 can be transformed into a matrix barcode that can be displayed by the first client device 109 for consumption by the second client device 109. Once block 815 has completed, the flowchart of FIG. 8 can come to an end.

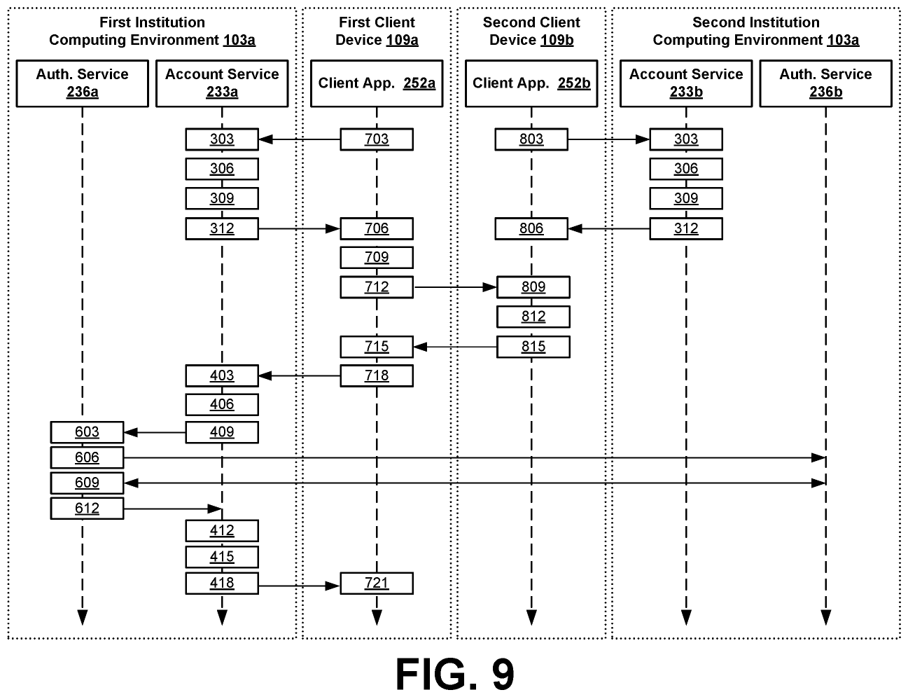

Moving on to FIG. 9, shown is sequence diagram that provides at least one example of the interactions between a first auth service 236a and a first account service 233a of a first institution computing environment 103a, a first client application 252a of a first client device 109a, a second client application 252b of a second client device 109b, and a second auth service 236b and a second account service 233b of a second institution computing environment 103b. The sequence diagram of FIG. 9 provides merely an example of the many different types of functional arrangements that can be employed by the first authorization service 236a, the first account service 233a, the first client application 252a, the second client application 252b, the second authorization service 236b, and the second account service 233b. As an alternative, the sequence diagram of FIG. 9 can be viewed as depicting examples of elements of one or more method implemented within the network environment 200.

To begin, client application 252a of the first client device 109a can obtain a first account DID 112 from the account service 233a of the first institution computing environment 103a, as previously described in block 703 of FIG. 7, which the account service 233a can receive, as previously described in block 303 of FIG. 3. The account service 233a of the first institution computing environment 103a can generate a first account DID 112, as previously described in block 306 of FIG. 3. Then, the account service 233a of the first institution computing environment 103a can generate a first VC 115, as previously described in block 309 of FIG. 3. Next, the account service 233a of the first institution computing environment 103a can send the first account DID 112 and/or the first VC 115 to the client application 252a of the first client device 109a, as previously described in block 312 of FIG. 3, which the client application 252a of the first client device 109a can receive, as previously described in block 706 of FIG. 7.

Additionally, client application 252b of the second client device 109b can obtain a second account DID 112 from the account service 233b of the second institution computing environment 103b, as previously described in block 803 of FIG. 8, which the account service 233b can receive, as previously described in block 303 of FIG. 3. The account service 233b of the second institution computing environment 103b can generate a second account DID 112, as previously described in block 306 of FIG. 3. Then, the account service 233b of the second institution computing environment 103b can generate a second VC 115, as previously described in block 309 of FIG. 3. Next, the account service 233b of the second institution computing environment 103b can send the second account DID 112 and/or the second VC 115 to the client application 252b of the second client device 109b, as previously described in block 312 of FIG. 3, which the client application 252b of the second client device 109b can receive, as previously described in block 806 of FIG. 8.

Next, the client application 252a of the first client device 109a can sign the first VC 115 with a private key associated with the first account DID 112, as previously described in block 709 of FIG. 7. Then the client application 252a of the first client device 109a can send a transfer request to the client application 252b of the second client device 109b, as previously described in block 712 of FIG. 7, which the client application 252b of the second client device 109b can receive, as previously described in block 809 of FIG. 8. Next, the client application 252b of the second client device 109b can generate a transfer DID 118, as previously described in block 812 of FIG. 8. Then the client application 252b of the second client device 109b can send the send the transfer DID 118 to the client application 252a of the first client device 109a, as previously described in block 815 of FIG. 8, which the client application 252a of the first client device 109a can receive, as previously described in block 715 of FIG. 7.

Next, the client application 252a of the first client device 109a can send the transfer DID 118 to the account service 233a of the first institution computing environment 103a, as previously described in block 718 of FIG. 7, which the account service 233a of the first institution computing environment 103a can receive, as previously described in block 403 of FIG. 4. The account service 233a of the first institution computing environment 103a can then verify the transfer DID 118, as previously described in block 406 of FIG. 4. Then the account service 233a of the first institution computing environment 103a can authorize a transfer with the authorization service 236a of the first institution computing environment 103a, as previously described in block 409 of FIG. 4.

Next, the authorization service 236a of the first institution computing environment 103a can generate an authorization DID, as previously described in block 603 of FIG. 6. The authorization service 236a of the first institution computing environment 103a can then send the authorization DID to the authorization service 236b of the second institution computing environment 103b, as previously described in block 606 of FIG. 6. The authorization service 236a of the first institution computing environment 103a can then initiate the transfer between the authorization service 236a of the first institution computing environment 103a and the authorization service 236b of the second institution computing environment 103b, as previously described in block 609 of FIG. 6. Once the transfer has completed, the authorization service 236a of the first institution computing environment 103a can notify the account service 233a of the first institution computing environment 103a that the transfer has completed, as previously described in block 612 of FIG. 6.

Then, in response to completing the transfer, the account service 233a of the first institution computing environment 103a can generate a third VC 115, as previously described in block 412 of FIG. 4. The account service 233a of the first institution computing environment 103a can then revoke the first VC 115, as previously described in block 415 of FIG. 4. The account service 233a of the first institution computing environment 103a can then send the updated VC 115 to the client application 252a of the first client device 109a, as previously described in block 418 of FIG. 4, which the client application 252a of the first client device 109a can receive, as previously described in block 721 of FIG. 7. Subsequently, the sequence diagram of FIG. 9 can come to an end.

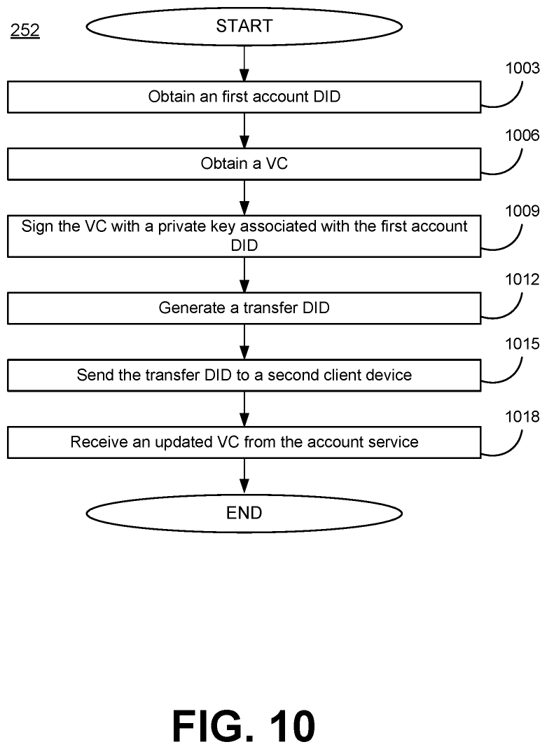

Referring next to FIG. 10, shown is a flowchart that provides one example of the operation of a portion of the client application 252. The flowchart of FIG. 10 provides merely an example of the many different types of functional arrangements that can be employed to implement the operation of the depicted portion of the client application 252. As an alternative, the flowchart of FIG. 10 can be viewed as depicting an example of elements of a method implemented within the network environment 200.

Beginning with block 1003, the client application 252 can obtain a first account DID 112. In at least some embodiments, the client application 252 can obtain a first account DID 112 from a first institution computing environment 103. The client application 252 can send a request to obtain an account DID to the account service 233 of the first institution computing environment 103. In at least some embodiments, the request to obtain the first account DID 112 can include various personal information and/or account information 224. The personal information and/or account information 224 can be used to identify a user account 212 that includes one or more account DIDs 112c. In some embodiments, the request to obtain the first account DID 112 can include an account public key 245. The client application 252 can receive the requested account DID 112 from the first institution computing environment 103.

Continuing to block 1006, the client application 252 can obtain a first VC 115. In at least some embodiments, the client application 252 can request a first VC from an account service 233 of a first institution computing environment 103. In response, the account service 233 of the first institution computing environment 103 can send a first VC 115. In at least another embodiment, the account service 233 of the first institution computing environment can receive the first VC 115 without having to send a request. The first VC 115 can include one or more claims about the associated account identified by the account DID 112. For instance, the account service 233 can generate a first VC 115 that includes a claim about a purchasing power (e.g., a credit limit, a bank account balance, the sum thereof, etc.) for one or more accounts associated with the user account 212 and the account DID 112. In at least another embodiment, the account service 233 can generate a first VC 115 that includes a claim about a transfer limit (e.g., a data transfer limit, a maximum data quota, etc.) for one or more accounts associated with the user account 212 and the account DID 112. The first VC 115 can be signed by the institution private key 230.

Next, at block 1009, the client application 252 can sign the first VC 115 with a private key associated with the first account DID 112. In at least some embodiments, the client application 252 can sign the first VC 115 with the account private key 248, which can be associated with the first account DID 112. By signing the first VC 115, the client application 252 is co-signing that the claims described in the first VC 115 are true. In at least some embodiments, the first VC 115 can be signed by both the institution private key 230 as well as the account private key 248, which indicates that both the institution and the user can allege the validity of the claim is true.

Continuing to block 1012, the client application 252 can generate a transfer DID 118. The transfer DID 118 can represent a transfer of information (e.g., data, currency, etc.) rather than an identity of a user 106, institution, or their respective computing devices. For example, a transfer DID 118 can represent a financial transaction between two parties. In another example, a transfer DID 118 can represent a data transfer between two computing devices. In various examples, a transfer DID 118 can include an address to a DID document, such as the DID document 221a, DID document 221b, or DID document 221c. The DID document 221 associated with the transfer DID 118 can include information associated with the transfer, like the first account DID 112, the first VC 115, network information about the client device 109, information about the transfer (e.g., a transaction amount, files to transfer, etc.), and various other information. The DID document 221 associated with the transfer DIDs 118 can be hosted on any computing environment, such as the institution computing environment 103, client device 109, or any other computing environment, or any other distributed ledger 203. In some embodiments, any of the DID documents 221a, DID document 221b, or DID document 221c associated with transfer DID 118 can be shared peer-to-peer, rather than being shared from a centralized location. In various examples, the transfer DIDs 118 can be implemented using various standards, such as a version of the World Wide Web Consortium's (W3C's) Decentralized Identifier (DID) standard. In at least some embodiments, the transfer DIDs 118 can be implemented as a peer DID. Peer DIDs can be implemented using various standards, such as a version of the World Wide Web Consortium's (W3C's) peer DID method specification.

Continuing to block 1015, the client application 252 can send the transfer DID 118 to the second client device 109. In at least some embodiments, the transfer DID 118 can be sent through various channels, such as email, SMS messages, Bluetooth, and/or other various messaging channels. In some embodiments, the transfer DID 118 can be transformed into a matrix barcode that can be displayed by the first client device 109 for consumption by the second client device 109.

Continuing to block 1018, the client application 252 can receive a second VC 115. The account service 233 of the first institution computing environment can receive the second VC 115 without having to send a request. In some embodiments, the second VC 115 can be received in response to the transfer being completed. In at least another embodiment, the second VC 115 can be received when information about the user accounts 212 has been changed. The second VC 115 can include one or more updated claims about the associated account identified by the account DID 112. For instance, the account service 233 can generate the second VC 115 having an updated claim about the purchasing power (e.g., a credit limit, a bank account balance, the sum thereof, etc.) for one or more accounts associated with the user account 212 and the account DID 112. The purchasing power can be modified (e.g., increased, decreased, etc.) as a result of the transfer being completed. In at least another embodiment, the account service 233 can generate second VC 115 that includes a claim about a transfer limit (e.g., a data transfer limit, a maximum data quota, etc.) for one or more accounts associated with the user account 212 and the account DID 112. The second VC 115 can be signed by the institution private key 230. Once block 1018 has completed, the flowchart of FIG. 10 can come to an end.

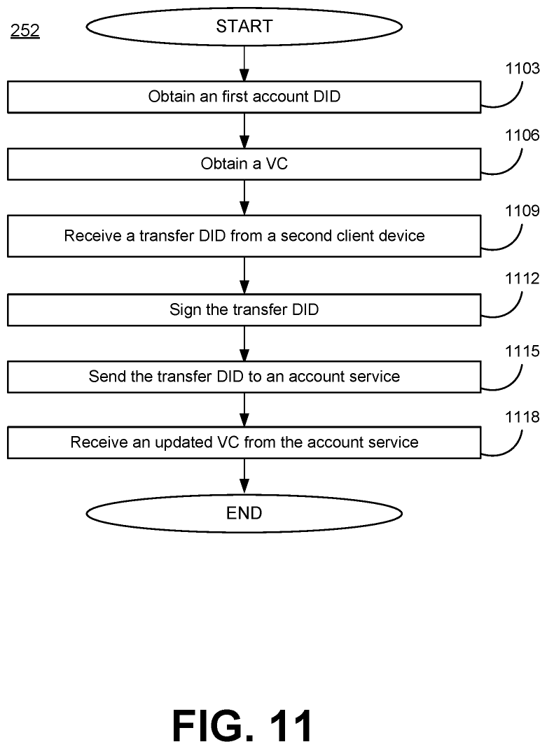

Referring next to FIG. 11, shown is a flowchart that provides one example of the operation of a portion of the client application 252. The flowchart of FIG. 11 provides merely an example of the many different types of functional arrangements that can be employed to implement the operation of the depicted portion of the client application 252. As an alternative, the flowchart of FIG. 11 can be viewed as depicting an example of elements of a method implemented within the network environment 200.

Beginning with block 1103, the client application 252 can obtain a first account DID 112. In at least some embodiments, the client application 252 can obtain a first account DID 112 from a first institution computing environment 103. The client application 252 can send a request to obtain an account DID to the account service 233 of the first institution computing environment 103. In at least some embodiments, the request to obtain the first account DID 112 can include various personal information and/or account information 224. The personal information and/or account information 224 can be used to identify a user account 212 that includes one or more account DIDs 112c. In some embodiments, the request to obtain the first account DID 112 can include an account public key 245. The client application 252 can receive the requested account DID 112 from the first institution computing environment 103.

Continuing to block 1106, the client application 252 can obtain a first VC 115. In at least some embodiments, the client application 252 can request a first VC from an account service 233 of a first institution computing environment 103. In response, the account service 233 of the first institution computing environment 103 can send a first VC 115. In at least another embodiment, the account service 233 of the first institution computing environment can receive the first VC 115 without having to send a request. The first VC 115 can include one or more claims about the associated account identified by the account DID 112. For instance, the account service 233 can generate a first VC 115 that includes a claim about a purchasing power (e.g., a credit limit, a bank account balance, the sum thereof, etc.) for one or more accounts associated with the user account 212 and the account DID 112. In at least another embodiment, the account service 233 can generate a first VC 115 that includes a claim about a transfer limit (e.g., a data transfer limit, a maximum data quota, etc.) for one or more accounts associated with the user account 212 and the account DID 112. The first VC 115 can be signed by the institution private key 230.

Next, at block 1109, the client application 252 can receive a transfer DID 118 from the second client device 109. In various examples, a transfer DID 118 can include an address to a DID document, such as the DID document 221a, DID document 221b, or DID document 221c. The transfer DID 118 or its corresponding DID document 221 can include instructions on how to perform a transfer. In at least some embodiments, a transfer DID 118 can represent a financial transaction between two parties. In at least another embodiment, a transfer DID 118 can represent a data transfer between two computing devices. The transfer DID 118 or its corresponding DID document 221 can include information that identifies information related to the transferor (e.g., an account DID 112, a did document 221, account info 224, etc.), information related to the transferee (e.g., an account DID 112, a did document 221, account info 224, etc.), a transfer subject (e.g., an amount to transfer, one or more files to be transferred, etc.), one or more VCs 115, and various other information. In some embodiments, the transfer DID 118 itself can be received along with one or more DID documents 221.

Continuing to block 1112, the client application 252 can sign the transfer DID 118 with a private key associated with the first account DID 112. In at least some embodiments, the client application 252 can sign the transfer DID 118 with the account private key 248, which can be associated with the first account DID 112. By signing the transfer DID 118, the client application 252 is agreeing that the terms listed in the transfer DID 118 are acceptable.

Next, at block 1115, the client application 252 can send the transfer DID 118 to the account service 233 of the first institution computing environment 103. In at least one embodiment, the client application 252 can forward the transfer DID 118 to the account service 233 of the first institution computing environment 103. In some embodiments, the client application 252 can first validate or verify information in the transfer DID prior to sending the transfer DID 118 to the account service 233 of the first institution computing environment 103.

Continuing to block 1118, the client application 252 can receive a second VC 115. The account service 233 of the first institution computing environment can receive the second VC 115 without having to send a request. In some embodiments, the second VC 115 can be received in response to the transfer being completed. In at least another embodiment, the second VC 115 can be received when information about the user accounts 212 has been changed. The second VC 115 can include one or more updated claims about the associated account identified by the account DID 112. For instance, the account service 233 can generate the second VC 115 having an updated claim about the purchasing power (e.g., a credit limit, a bank account balance, the sum thereof, etc.) for one or more accounts associated with the user account 212 and the account DID 112. The purchasing power can be modified (e.g., increased, decreased, etc.) as a result of the transfer being completed. In at least another embodiment, the account service 233 can generate second VC 115 that includes a claim about a transfer limit (e.g., a data transfer limit, a maximum data quota, etc.) for one or more accounts associated with the user account 212 and the account DID 112. The second VC 115 can be signed by the institution private key 230. Once block 1118 has completed, the flowchart of FIG. 11 can come to an end.

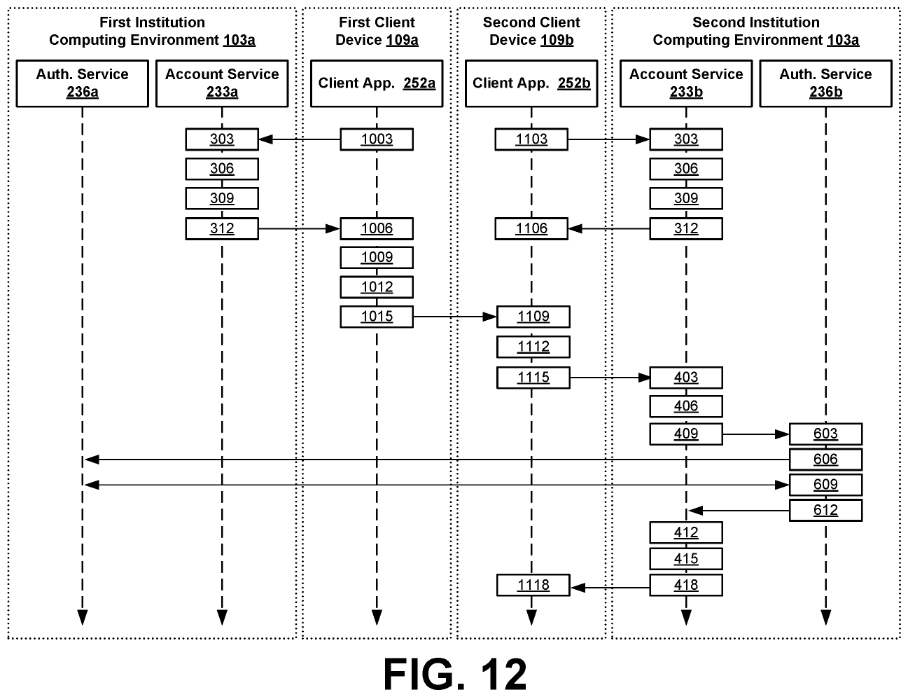

Moving on to FIG. 12, shown is sequence diagram that provides at least one example of the interactions between a first auth service 236a and a first account service 233a of a first institution computing environment 103a, a first client application 252a of a first client device 109a, a second client application 252b of a second client device 109b, and a second auth service 236b and a second account service 233b of a second institution computing environment 103b. The sequence diagram of FIG. 12 provides merely an example of the many different types of functional arrangements that can be employed by the first authorization service 236a, the first account service 233a, the first client application 252a, the second client application 252b, the second authorization service 236b, and the second account service 233b. As an alternative, the sequence diagram of FIG. 12 can be viewed as depicting examples of elements of one or more method implemented within the network environment 200.

To begin, client application 252a of the first client device 109a can obtain a first account DID 112 from the account service 233a of the first institution computing environment 103a, as previously described in block 1003 of FIG. 10, which the account service 233a can receive, as previously described in block 303 of FIG. 3. The account service 233a of the first institution computing environment 103a can generate a first account DID 112, as previously described in block 306 of FIG. 3. Then, the account service 233a of the first institution computing environment 103a can generate a first VC 115, as previously described in block 309 of FIG. 3. Next, the account service 233a of the first institution computing environment 103a can send the first account DID 112 and/or the first VC 115 to the client application 252a of the first client device 109a, as previously described in block 312 of FIG. 3, which the client application 252a of the first client device 109a can receive, as previously described in block 1006 of FIG. 10.

Additionally, client application 252b of the second client device 109b can obtain a second account DID 112 from the account service 233b of the second institution computing environment 103b, as previously described in block 1103 of FIG. 11, which the account service 233b can receive, as previously described in block 303 of FIG. 3. The account service 233b of the second institution computing environment 103b can generate a second account DID 112, as previously described in block 306 of FIG. 3. Then, the account service 233b of the second institution computing environment 103b can generate a second VC 115, as previously described in block 309 of FIG. 3. Next, the account service 233b of the second institution computing environment 103b can send the second account DID 112 and/or the second VC 115 to the client application 252b of the second client device 109b, as previously described in block 312 of FIG. 3, which the client application 252b of the second client device 109b can receive, as previously described in block 1106 of FIG. 11.

Next, the client application 252a of the first client device 109a can sign the first VC 115 with a private key associated with the first account DID 112, as previously described in block 1009 of FIG. 10. The client application 252a of the first client device 109a can then generate a transfer DID 118, as previously described in block 1012 of FIG. 10. The client application 252a of the first client device 109a can then send the transfer DID 118 to the client application 252b of the second client device 109b, as previously described in block 1015 of FIG. 10, which the client application 252b of the second client device 109b can receive, as previously described in block 1109 of FIG. 11. The client application 252b of the second client device 109b can then sign the transfer DID 118 with a private key associated with the second account DID 112, as previously described in block 1112 of FIG. 11.

Next, the client application 252b of the second client device 109b can send the transfer DID 118 to the account service 233b of the second institution computing environment 103b, as previously described in block 1115 of FIG. 11, which the account service 233b of the second institution computing environment 103b can receive, as previously described in block 403 of FIG. 4. The account service 233b of the second institution computing environment 103b can then verify the transfer DID 118, as previously described in block 406 of FIG. 4. Then the account service 233b of the second institution computing environment 103b can authorize a transfer with the authorization service 236b of the second institution computing environment 103b, as previously described in block 409 of FIG. 4.

Next, the authorization service 236b of the second institution computing environment 103b can generate an authorization DID, as previously described in block 603 of FIG. 6. The authorization service 236b of the second institution computing environment 103b can then send the authorization DID to the authorization service 236a of the first institution computing environment 103a, as previously described in block 606 of FIG. 6. The authorization service 236b of the second institution computing environment 103b can then initiate the transfer between the authorization service 236a of the first institution computing environment 103a and the authorization service 236b of the second institution computing environment 103b, as previously described in block 609 of FIG. 6. Once the transfer has completed, the authorization service 236b of the second institution computing environment 103b can notify the account service 233b of the second institution computing environment 103b that the transfer has completed, as previously described in block 612 of FIG. 6.

Then, in response to completing the transfer, the account service 233b of the second institution computing environment 103b can generate a third VC 115, as previously described in block 412 of FIG. 4. The account service 233b of the second institution computing environment 103b can then revoke the first VC 115, as previously described in block 415 of FIG. 4. The account service 233b of the second institution computing environment 103b can then send the updated VC 115 to the client application 252b of the second client device 109b, as previously described in block 418 of FIG. 4, which the client application 252b of the second client device 109b can receive, as previously described in block 1118 of FIG. 11. Subsequently, the sequence diagram of FIG. 12 can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same network environment 200.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive, from a client device, a transfer peer decentralized identifier (DID) comprising at least a first account peer DID, a second account peer DID, and instructions to initiate a transfer for a transfer amount between a first user record and a second user record, the first user record being identified by the first account peer DID, and the second user record being identified by the second account peer DID;
generate a verifiable credential (VC) for the first account peer DID, the VC comprising at least an authorization amount, the authorization amount representing an account balance that has been increased or decreased by the transfer amount, and the VC being signed by an institution DID; and
send, to the client device, the VC.

2. The system of claim 1, wherein:
the VC is a second VC;
the authorization amount is a second authorization amount;
the account balance is a second account balance; and
the machine-readable instructions, when executed by the processor and prior to receiving the transfer peer DID, further cause the computing device to at least:
generate the first account peer DID that corresponds to the first user record;
generate a first VC for the first account peer DID, the first VC comprising at least a first authorization amount, the first authorization amount representing a first account balance, and the first VC being signed by a first private key associated with the institution DID; and
send, to the client device, the first account peer DID and the first VC.

3. The system of claim 2, wherein the machine-readable instructions further cause the computing device to at least revoke the first VC in response to generating the second VC.

4. The system of claim 1, wherein the institution DID is stored on a distributed ledger.

5. The system of claim 4, wherein:
the institution DID is a first institution DID;
the first account peer DID is associated with the first institution DID;
the second account peer DID is associated with a second institution DID; and
the second institution DID is stored on the distributed ledger.

6. The system of claim 5, wherein:
the transfer peer DID is a first transfer peer DID;
the computing device is a first computing device, the first computing device being identified by the first institution DID;
the first computing device being in data communication with a second computing device, the second computing device being identified by the second institution DID; and
the machine-readable instructions, when executed by the processor, further cause the first computing device to at least:
generate a first institution peer DID, the first institution peer DID being representative of the first computing device in a private peer relationship between the first computing device and the second computing device;
send the first institution peer DID to the second computing device; and
receive, from the second computing device, a second institution peer DID, the second institution peer DID being representative of the second computing device in the private peer relationship between the first computing device and the second computing device.

7. The system of claim 6, wherein the machine-readable instructions, when executed by the processor, further cause the first computing device to at least:
generate an authorization DID comprising the instructions to initiate the transfer for the transfer amount between the first user record and the second user record; and
send the authorization DID to the second computing device.

8. The system of claim 7, wherein the machine-readable instructions further cause the first computing device to at least initiate the transfer for the transfer amount between the first user record maintained by the first computing device and the second user record maintained by the second computing device.

9. A method, comprising:
receiving, by a first client device from an account service, a first verifiable credential (VC) corresponding to a first account, the first VC comprising at least a first authorization amount, and the first VC being signed by a first institution private associated with an institution decentralized identifier (DID) publicly shared on a distributed ledger;
signing, by the first client device, the first VC with an account private key associated with a first account DID;
sending, by the first client device to a second client device, at least the first VC and a request to perform a transfer;
receiving, by the first client device from the second client device, a transfer DID comprising instructions to initiate the transfer for a transfer amount from the first account identified by the first account DID to a second account record identified by a second account DID; and
sending, by the first client device to the account service, the transfer DID.

10. The method of claim 9, wherein the first account DID was generated by the account service to uniquely identify the first client device.

11. The method of claim 9, wherein the first account DID was generated by the first client device as a peer DID in a private peer relationship between the first client device and the second client device.

12. The method of claim 9, further comprising receiving, by a first client device from an account service, a second VC corresponding to the first account, the second VC comprising at least a second authorization amount, the second authorization amount representing the first authorization amount having been increased or decreased by the transfer amount.

13. The method of claim 9, further comprising signing, by the first client device in response to receiving the transfer DID, the transfer DID with the account private key associated with the first account DID.

14. A non-transitory, computer-readable medium, comprising machine-readable instructions that, when executed by a processor of a computing device, cause the computing device to at least:
receive, from a client device, a transfer decentralized identifier (DID) comprising at least a first account DID, a second account DID, and instructions to initiate a transfer for a transfer amount between a first user record and a second user record, the first user record being identified by the first account DID, and the second user record being identified by the second account DID;
generate a verifiable credential (VC) for the first account DID, the VC comprising at least an authorization amount, the authorization amount representing an account balance that has been increased or decreased by the transfer amount, and the VC being signed by a first private key associated with an institution DID; and
send, to the client device, the VC.

15. The non-transitory, computer-readable medium of claim 14, wherein:
the VC is a second VC;
the authorization amount is a second authorization amount;
the account balance is a second account balance; and
the machine-readable instructions, when executed by the processor and prior to receiving the transfer DID, further cause the computing device to at least:
generate the first account DID that corresponds to the first user record;
generate a first VC for the first account DID, the first VC comprising at least a first authorization amount, the first authorization amount representing a first account balance, and the first VC being signed by the first private key associated with the institution DID; and
send, to the client device, the first account DID and the first VC.

16. The non-transitory, computer-readable medium of claim 15, wherein the machine-readable instructions, when executed by the processor, further cause the computing device to at least revoke the first VC in response to generating the second VC.

17. The non-transitory, computer-readable medium of claim 14, wherein:
the institution DID is a first institution DID;
the first account DID is associated with the first institution DID;
the first institution DID is stored on a distributed ledger;
the second account DID is associated with a second institution DID; and
the second institution DID is stored on the distributed ledger.

18. The non-transitory, computer-readable medium of claim 17, wherein:
the transfer DID is a first transfer DID;
the computing device is a first computing device, the first computing device being identified by the first institution DID;
the first computing device being in data communication with a second computing device, the second computing device being identified by the second institution DID; and
the machine-readable instructions, when executed by the processor, further cause the first computing device to at least:
generate a first institution DID, the first institution DID being representative of the first computing device in a private peer relationship between the first computing device and the second computing device;
send the first institution DID to the second computing device; and
receive, from the second computing device, a second institution DID, the second institution DID being representative of the second computing device in the private peer relationship between the first computing device and the second computing device.

19. The non-transitory, computer-readable medium of claim 18, wherein the machine-readable instructions, when executed by the processor, further cause the computing device to at least:
generate a second transfer DID comprising the instructions to initiate the transfer for the transfer amount between the first user record and the second user record; and
send the second transfer DID to the second computing device.

20. The non-transitory, computer-readable medium of claim 17, wherein the machine-readable instructions, when executed by the processor, further cause the computing device to at least verify a third VC was signed by a second private key associated with the second institution DID, the third VC being associated with the second account DID.
